(19) United States
(12) Patent Application Publication
(10) Pub. No.: US 2011/0209781 A1
(43) Pub. Date: Sep. 1, 2011

(54) SANITARY FITTING WITH AN OUTLET MADE OF GLASS

(75) Inventor: Andreas Fath, Haslach (DE)

(73) Assignee: Hansgrohe AG, Schiltach (DE)

(21) Appl. No.: 12/673,464

(22) PCT Filed: Jul. 18, 2008
(86) PCT No.: PCT/EP2008/005899

§ 371 Date: Feb. 12, 2010

(30) Foreign Application Priority Data
Aug. 21, 2007 (DE) 10 2007 040 495.8

(51) Int. Cl. F16K 21/00; F16K 37/00

(52) U.S. Cl. 137/551; 137/801; 137/560

(57) ABSTRACT

A sanitary fitting (1) has a housing (2), an outlet (3) and functional parts (4) for carrying water. In this case, the outlet (3) is formed on the housing (2) or is connected or can be connected to the housing (2). The functional parts (4) are preferably arranged inside the housing (2). In the case of this sanitary fitting, as claimed in the invention the outlet (3) is substantially free from water-carrying functional parts (4), and at least the outlet (3) and preferably also the housing (2) are produced substantially completely from glass.

The invention relates to a sanitary fitting with a housing, an outlet and functional parts for carrying water. The outlet is formed on the housing or is connected to the housing or can be connected to the housing. The functional parts for carrying water are preferably arranged inside the housing.

Sanitary fittings usually comprise the components mentioned in the introduction, i.e. housing, outlet and functional parts for carrying water. The housing is also frequently referred to as the base body of the sanitary fitting. The outlet comprises that part of the fitting out of which the water flows. The functional parts for carrying water are generally, on the one hand, the hoses or pipes which are used to supply the water (cold water, hot water) to the fitting and, on the other hand, those devices which are used to carry the water inside the fitting and mix it, for example, from cold water and hot water. These functional parts are also intended to include the valve elements, jet regulators and the like which are associated with the outlet.

Even today, sanitary fittings, in particular the housing or base body thereof, are still generally produced from cast brass. The sanitary fittings are then provided on the outer side with coatings, generally metal coatings, both for decorative reasons and for functional reasons. The best-known coating in this case is coating with chromium, and the advantages of this, in particular with respect to protection against corrosion, are readily known to a person skilled in the art. The chromium coating is generally applied using electroplating processes, with further metal layers also being provided underneath the chromium layer. The corresponding layer structures are also known to a person skilled in the art.

Sanitary fittings can also be coated on their inner sides in order, for example, to prevent the emergence of certain metals which may be present as impurity in the cast brass. Lead and other heavy metals, in particular, should be mentioned as such impurities.

However, existing processes for coating sanitary fittings, in particular those made from cast brass, have the fundamental disadvantage that they are relatively complicated. As already mentioned, electroplating processes require specific layer structures which, in general, lead to a large number of process steps including flushing processes and the like. As a result, the coating of sanitary fittings takes a long time and is expensive. Processes of this type are made even more complicated if it is also necessary to provide inner coatings, i.e. coatings on the surfaces which come into contact with the water flowing through the fitting.

WO 2005/064231 A1 shows a tap outlet (see FIG. 12 in said document) which is produced from a translucent material such as plastic, crystal or glass.

However, this sheath-type embodiment serves only for decorative purposes, in order to guide the light from light-emitting diodes which are arranged in the base of the outlet. The inside of the sheath, which is made from translucent material, is provided with a separate water line which guides the water from the base of the outlet to a jet regulator fitted on the end of the outlet.

Accordingly, the invention is based on the object of avoiding or at least considerably reducing the disadvantages mentioned. The intention is to provide a sanitary fitting which, from the outset, has a large number of positive properties. Therefore, it is firstly intended to prevent, from the outset, emergence of harmful substances from the surfaces which come into contact with the water flowing through the fitting. Secondly, the outer surfaces of the sanitary fitting should either, from the outset, have a high decorative quality or it should be possible to convert these into decorative surfaces in a simple manner.

This object is achieved by the sanitary fitting having the features of claim 1. Preferred embodiments of this sanitary fitting are defined in dependent claims 2 to 15. The wording of all the claims is hereby incorporated by reference in the content of this description.

According to the invention, the sanitary fitting with a housing, outlet and functional parts for carrying water, as mentioned in the introduction, is designed in such a manner that the outlet is substantially free from water-carrying functional parts and at least the outlet is produced substantially completely from glass. In these embodiments, it is preferred if not only the outlet but also the housing is produced substantially completely from glass.

Within the context of the invention, “free from water-carrying functional parts” means that no additional hoses, pipe lines and the like, through which the water flows inside the outlet, are provided inside the outlet produced from glass. Accordingly, the water flows unhindered inside the outlet and can freely come into contact with the inner surfaces, in particular directly with the glass surfaces, of the outlet.

Within the context of the application, “outlet” should generally be understood to mean that region which is downstream of the mixer cartridge.

Water-carrying functional parts are present in the outlet only inasmuch as a valve element or a jet regulator may be provided, for example, on the end of the outlet.

The fact that the outlet, and preferably also the housing, is produced substantially completely from glass in the case of the invention has the decisive advantage that firstly no impurities, for example heavy metals such as lead and the like, present in the outlet material or in the housing material can transgress from the corresponding surfaces into the water which flows through the outlet or the housing. This means that such impurities are excluded from the outset, and therefore legal limit values which may be present in respect of such impurities can easily be complied with.

The smooth inner surfaces also prevent the formation of deposits which, in turn, can form nests for bacteria. Therefore, the general quality of the water is improved.

In addition, glass is a material having very smooth, easy-to-clean surfaces. Glass surfaces are also very scratch-resistant. Furthermore, the outer surfaces of the outlet and also of the housing made from glass, in particular, can be modified further in a simple way, for example by applying additional decorative layers.

By way of example, layers such as these may be colored layers or else metal layers. It is possible to apply metal layers such as these, in particular, because consumers are used to the fact that sanitary fittings having a metal coating.

The use of glass additionally opens up completely new ways of designing sanitary fittings. By way of example, it is therefore possible deliberately not to coat the outlet further, and therefore the consumer can see the water flowing through the glass outlet when the fitting is in use. In this case, it is also possible to deliberately obtain special optical effects by coating, for example, different portions of the outlet, either with colored layers or with metal layers, and by leaving other portions transparent. By way of example, it may also be provided that the housing, in which the functional parts for carrying water are normally located, is coated, in particular with metal layers, on the outer surfaces so that the functional parts cannot be seen from the outside. The outlet itself can then deliberately be left transparent, i.e. uncoated.

In the invention, the term “glass” should be understood to be as comprehensive as possible. In the invention, preference is given to using what are known as inorganic glasses, the typical representatives of which are readily known to a person skilled in the art. The inorganic glass, which, according to the invention, is used to produce the outlet and the housing, is preferably conventional technical glasses such as quartz glass or lead silicate glass or, in particular, soda-lime silicate glass or borosilicate glass.

It is not a prerequisite that the glasses used according to the invention are transparent after they have been produced. The advantages whereby no impurities emerge from the inner surfaces which come into contact with the water and/or whereby the outer surfaces can advantageously be coated are, of course, also achieved with opaque, for example correspondingly colored, glass materials. However, opaque or transparent glasses can be used to obtain particularly special optical effects, and this further increases the number of possible variations of the different embodiments of the sanitary fittings. In addition, glass affords the advantage that profiled formations can easily be provided in the housing or, in particular, in the outlet. In this context, profiled formations should be understood to mean regions of differing thickness (wall thicknesses) in the material, such that, for example, certain regions taper or thicken in their wall thickness, possibly also at regular intervals. By way of example, this makes it possible to increase the strength of the material or specific optical effects can be achieved, in particular, in the glass material.

As already mentioned, it is particularly advantageous in the invention if the housing and/or the outlet is/are at least partially provided on its/their inner side and/or outer side with a coating.

In principle, such a coating can also be provided on the inner sides of the housing or of the outlet. As already mentioned, such a coating is not required in order to prevent the emergence of impurities from the glass material itself. In the present case, such coatings primarily serve for decorative purposes. By way of example, it is therefore possible to provide an inner coating of this type such that the outlet or the housing appears partially or completely invisible to the viewer, but the glass material remains visible from the outside. In this way, for example, functional parts present inside the housing can remain invisible to the viewer, and the optical impression of a glass sanitary fitting can nevertheless be retained.

However, particular preference is given to embodiments of the sanitary fitting in which the outer sides are at least partially coated and then preferably no coating is provided on the inner sides.

In a development of the preferred embodiments, the coating is a coating of a metal or a metal alloy. Metals or metal alloys can be used, in particular, to provide the decorative surfaces which are known to consumers for sanitary fittings and which consumers desire for sanitary fittings. In particular, the metal is zirconium, titanium or chromium, with preference being given to the provision of shiny coatings.

Furthermore, the metal or the metal alloy may be a precious metal or a precious metal alloy. Examples of precious metals which should be mentioned here are silver and gold, and examples of precious metal alloys which should be mentioned are those which contain palladium or platinum as alloy constituent.

Furthermore, in this context it is also necessary to mention alloys which contain ruthenium; here, in turn, emphasis should be placed on nickel-chromium-ruthenium alloys.

Furthermore, the outer surfaces of the outlet and/or of the housing can be provided with metal layers which create the optical impression of a steel surface for the viewer. These metal layers may be alloy layers of palladium-nickel or nickel-tungsten.

The coatings mentioned are preferably applied to the surfaces of the sanitary fitting, in particular of the outlet or of the housing, in a PVD (physical vapor deposition) process or in a CVD (chemical vapor deposition) process. In connection with the CVD processes, mentioned should be made here in particular of the atomic layer deposition (ALD) process. All of these processes are known, in principle, to a person skilled in the art.

The advantages of the present invention are particularly effective in connection with the PVD and

CVD processes mentioned. As mentioned in the introduction, sanitary fittings produced from standard materials such as cast brass are generally coated by electroplating. This results in long processes with a large number of process steps. The use of glass as the material for the outlet and the housing makes it possible to apply hard coatings, in particular hard metal coatings, to a hard surface, specifically the glass surface. As a result, the PVD and CVD processes mentioned are particularly suitable for coating the sanitary fittings according to the invention. The glass surfaces are scratch-resistant and smooth, and this makes it possible to dispense with complicated grinding processes which are necessary in the case of cast brass. The activation of the glass surfaces for the PVD and CVD processes mentioned is not critical and is known to a person skilled in the art. It can be carried out, for example, by wet-chemical means with the aid of oxidizing solutions.

All conventional functional parts which are readily known to a person skilled in the art can be used as functional parts for carrying water. Ultimately, these functional parts are not critical for implementing the invention.

In the sanitary fittings according to the invention, preference is given to using so-called mixer cartridges as functional parts, as are described, for example, in DE 100 11 505 A1. In this respect, the content of this laid-open publication is expressly incorporated by reference in the content of this description.

The embodiments described in DE 100 11 505 A1 make it possible for the functional parts provided for carrying water, in the present case comprising the “base part” and the “intermediate element”, to be inserted in the housing of the sanitary fitting in a simple manner. In this case, embodiments can also preferably be provided in which the mixer cartridge forms a structural unit together with other water-carrying functional parts.

In a development, the sanitary fitting according to the invention can be provided with sensor elements for actuating the fitting and/or for measuring the through-flow, the speed, the temperature and the like of the water flowing through. Sensor elements such as these are known to a person skilled in the art and may preferably also be integrated in the corresponding functional parts, i.e. for example in mixer cartridges.

In another development, according to the invention connecting elements for connecting the functional parts to the housing or the outlet are provided. In this context, reference is made to the appended drawings. In this case, these connecting elements may be sleeve-like or nipple-like connecting elements, preferably made from plastic. By way of example, these may be adhesively fixed in the corresponding components, preferably the housing, or can be fixed with the aid of fastening or locking means, for example pins or sleeves made from plastic.

Furthermore, light-emitting elements, e.g. light-emitting diodes, can be provided to achieve specific optical effects. Lighting means such as these make it possible to utilize or further improve the possible ways of embodying the present invention.

Further features, details and advantages of the invention emerge from the following description of two preferred embodiments of the invention and on the basis of the drawings, in which:

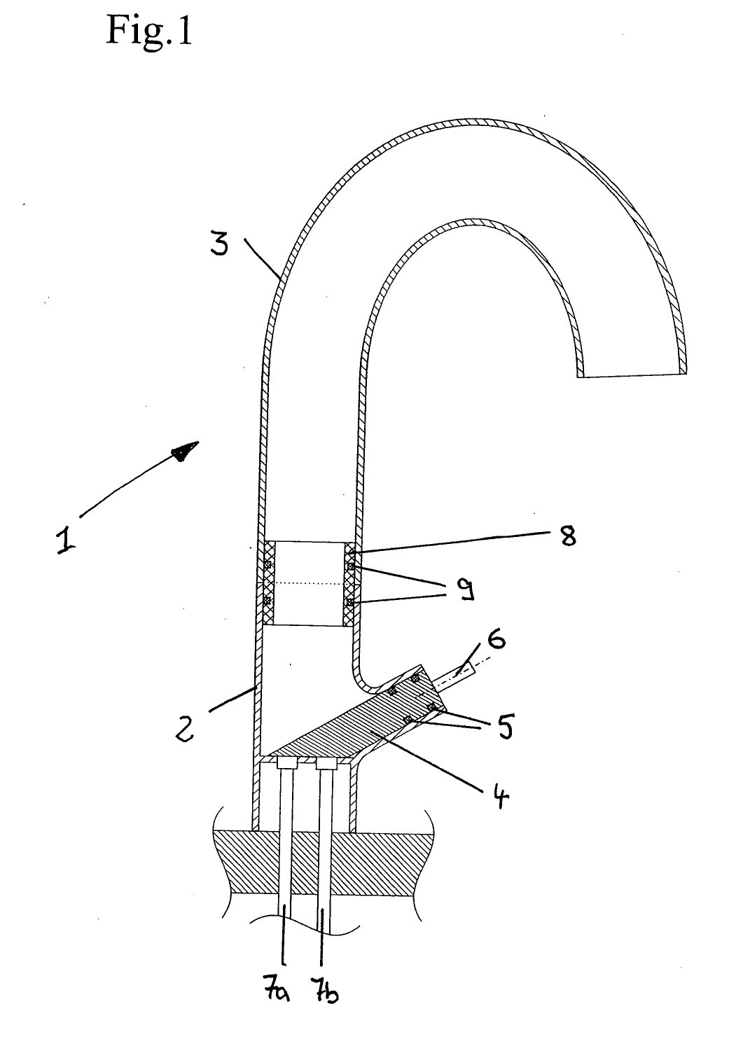

FIG. 1 shows a first embodiment of a sanitary fitting according to the invention in a schematic sectional illustration, and

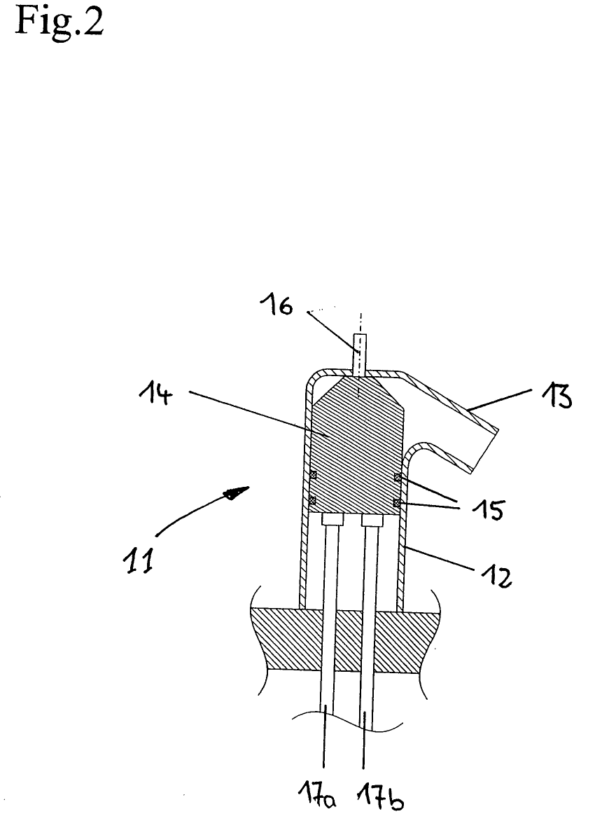

FIG. 2 shows a second embodiment of a sanitary fitting according to the invention in a schematic sectional illustration.

The sanitary fitting 1 according to the invention comprises a housing 2 and an outlet 3. In the present case, the housing 2 is produced from cast brass, whereas the outlet 3 is produced from a borosilicate glass.

The inside of the housing 2 is provided with a mixer cartridge 4 which is aligned with the corresponding parts of the housing 2 with the aid of suitable sealing elements 5. The mixer cartridge 4 is assigned an actuating element 6 which can be used to mix the cold water and hot water flowing in via the feed lines 7a and 7b respectively and to pass this mixture on in the direction of the outlet. This is shown merely schematically in FIG. 1.

The housing 2 and the outlet 3 are connected to suitable sealing elements 9 via a nipple-like connecting element 8. In this way, the housing 2 made from cast brass can be assembled together with the outlet 3 made from glass material.

In accordance with the preceding description, FIG. 1 accordingly shows an embodiment of the invention in which (only) the outlet is produced from glass material. No water-carrying elements are provided inside the outlet 3, and therefore the water emerging from the mixer cartridge 4 can flow substantially freely through the outlet 3 and come into direct contact with the inner glass surfaces. Accordingly, the consumer or user can easily observe the stream of water inside the outlet and the resulting optical effects.

As already mentioned, in this case the outer surface of the outlet, in particular, can additionally be coated in order to produce further optical effects.

As compared with the embodiment shown in FIG. 1, the embodiment shown in FIG. 2 has been modified to the extent that both the housing 12 and the outlet of this sanitary fitting 11 are produced from borosilicate glass. Here, FIG. 2 shows a one-part design of the sanitary fitting 11. However, it is similarly possible to implement embodiments in which a separately produced housing of glass and a separately produced outlet of glass, as in an embodiment shown in FIG. 1, are connected to each other from two parts.

In the embodiment shown in FIG. 2, a mixer cartridge 14 having suitable sealing elements 15 is likewise arranged inside the housing 12. Here, too, an actuating element 16 is correspondingly provided and this is used to regulate the cold water and hot water flowing in through feed lines 17a and 17b respectively and to deflect it in the direction of the outlet. The flow of water is likewise not shown in more detail in FIG. 2.

A large number of the outlined advantages of the invention are effective in the embodiment shown in FIG. 2. Since the housing 12 and outlet 13 are produced from glass, there are no inner surfaces from which impurities, in particular heavy metals, could emerge. Accordingly, legal regulations which may be present are readily complied with; in the case of cast brass sanitary fittings, for example, this can be ensured only by complicated additional measures, in particular coatings. In addition, outwardly hard, scratch-resistant surfaces are provided, according to FIG. 2, both for the housing 12 and for the outlet 13. These surfaces can then, if appropriate, be coated (not shown in more detail in FIG. 2) partially or completely with the aid of comparatively simple processes, for example with the aid of a PVD process. Reference is made expressly to the corresponding parts of the preceding description.

1. A sanitary fitting, comprising:
a housing,
an outlet, wherein the outlet is one of formed on the housing, connected to the housing and connectable to the housing (2; 12), and
functional parts for carrying water,
wherein the outlet is substantially free from water-carrying functional parts and at least the outlet is produced substantially completely from glass.

2. The sanitary fitting as claimed in claim 1, wherein the glass comprises an inorganic glass.

3. The sanitary fitting as claimed in claim 1, wherein at least one of the housing and the outlet is at least partially provided on at least one of an inner side and an outer side thereof with a coating.

4. The sanitary fitting as claimed in claim 3, wherein the coating is provided only on the outer side of said at least one of the housing and the outlet.

5. The sanitary fitting as claimed in claim 3, wherein the coating comprises one of a metal and a metal alloy.

6. The sanitary fitting as claimed in claim 5, wherein the metal is zirconium.

7. The sanitary fitting as claimed in claim 5, wherein said one of the metal and the metal alloy comprises one of a precious metal and a precious metal alloy.

8. The sanitary fitting as claimed in claim 7, wherein the metal alloy comprises a ruthenium-containing alloy.

9. The sanitary fitting as claimed in claim 3, wherein the coating is applied in one of a PVD (physical vapor deposition) process and a CVD (chemical vapor deposition) process.

10. The sanitary fitting as claimed in claim 1, wherein a mixer cartridge is provided as one of the functional parts.

11. The sanitary fitting as claimed in claim 10, wherein the mixer cartridge forms a structural unit together with at least one other of the water-carrying functional parts.

12. The sanitary fitting as claimed in claim 1, further comprising at least one element for at least one of actuating the fitting and sensing at least one attribute of water flowing through the fitting.

13. The sanitary fitting as claimed in claim 1, further comprising connecting elements for connecting the functional parts to at least one of the housing and the outlet (3;13).

14. The sanitary fitting as claimed in claim 13, wherein the connecting elements comprise plastic.

15. The sanitary fitting as claimed in claim 1, further comprising lighting means to achieve optical effects.

16. The sanitary fitting of claim 1, wherein the functional parts are arranged inside the housing.

17. The sanitary fitting of claim 1, wherein the housing also is produced substantially completely from glass.

18. The sanitary fitting as claimed in claim 2, wherein the glass comprises one of soda-lime silicate glass and borosilicate glass.

19. The sanitary fitting as claimed in claim 8, wherein the metal alloy comprises a nickel-chromium-ruthenium alloy.

20. The sanitary fitting as claimed in claim 12, wherein the at least one element comprises a sensor element responsive to at least one of flow, speed and temperature of the water flowing through the fitting.

21. The sanitary fitting as claimed in claim 14, wherein the connecting elements are adhesively fixed in one of the housing and the outlet.

22. The sanitary fitting as claimed in claim 15, wherein the lighting means comprise at least one light-emitting diode.
